(19) United States
(12) Patent Application Publication
(10) Pub. No.: US 2006/0159035 A1
(43) Pub. Date: Jul. 20, 2006

(54) Apparatus and method to detect collisions of data packets

(76) Inventors: Shai Waxman, Haifa (IL); Rony Ross, Tel-Aviv (IL)

Correspondence Address: PEARL COHEN ZEDEK LATZER, LLP, 1500 BROADWAY, 12TH FLOOR, NEW YORK, NY, 10036, US

(21) Appl. No.: 11/037,184

(22) Filed: Jan. 19, 2005

(51) Int. Cl. H04B 1/44; H04L 12/413

(52) U.S. Cl. 370/282; 370/445

(57) ABSTRACT

Briefly, a method and apparatus to detect a collision of a received signal and a transmission of the unacknowledged data message and performing a retransmission of the unacknowledged data message upon a detection of the collision.

### BACKGROUND OF THE INVENTION

A wireless local area network (WLAN) may include a basic service set (BSS). The BSS may include an access point (AP) and one or more stations (STA). The station and/or the AP may transmit unacknowledged data packets, which may be referred to as broadcast/multicast packets, to other stations and/or APs. The broadcast packets may be used by various applications such as, for example, streaming video/audio, game servers, or the like.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention; and

FIG. 2 is a schematic flow chart of a method for detecting a received signal while transmitting an unacknowledged data message according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

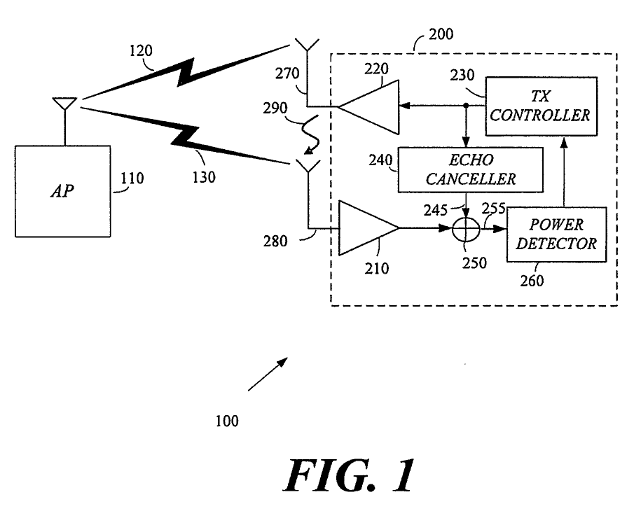

Turning first to FIG. 1, a wireless communication system 100, for example, a WLAN, according to embodiments of the present invention, is shown. Although the scope of the present invention is not limited in this respect, the exemplary WLAN 100 may be defined, e.g., by the IEEE 802.11-1999 standard, as a BSS. For example, the BSS may include at least one communication station, for example, a station 200, and an access point (AP) 110, if desired.. According to this embodiment of the invention, station 200 may include a receiver (RX) 210, a transmitter (TX) 220, a transmitter controller 230, an echo canceller 240, a combiner 250, a detector 260 and antennas 270 and 280.

Although the scope of the present invention is not limited in this respect, either or both of antennas 270 and 280 may include an omni-directional antenna, a monopole antenna, a dipole antenna, an end fed antenna, a circularly polarized antenna, a micro-strip antenna, a diversity antenna, an antenna array, an internal antenna or the like. In this exemplary embodiment of the invention antenna 270 may be coupled to transmitter 220 and may transmit an unacknowledged data message 120, and antenna 280 may be coupled to receiver 210 and may receive a signal 130 from AP 110, if desired.

According to embodiments of the present invention, unacknowledged data message 120 may be broadcasted by station 200 and/or AP 110 to one or more stations and/or APs of WLAN 100 without being acknowledged by the recipient stations and/or APs. Thus, the broadcasting station, for example station 200, may not be able to confirm reception of unacknowledged data message 120 by the recipient stations and/or APs.

Although the scope of the present invention is not limited in this respect, a separation 290 between antennas 270 and 280 may be adjusted to a predetermined value, for example, on the order of 40 dBm or higher, if desired. According to some embodiments of the invention, separation 290 may be adjusted, for example, by controlling polarization of antennas 270, 280, by modifying a distance between antennas 270, 280, or the like.

According to some exemplary embodiments of the invention, antenna 270 may transmit unacknowledged data message 120 at a predetermined power level, for example, about 10 dBm. Antenna 280 may receive the received signal 130. For example, a received signal power may be, for example, about −30 dBm. Echo canceller 240 may cancel an echo of unacknowledged data message 120 at receiver 210 and may provide a canceling signal 245 to detector 260, if desired. Canceling signal 245 may be related to a power value of the echo of the unacknowledged data message 120. For example, echo canceller 240 may reduce the power of the echo of unacknowledged data message 120 to a value below −60 dBm, although the scope of the present invention is not limited to this example.

According to some embodiments of the present invention, echo canceller 240 may include a filter, for example, a Finite Impulse Response (FIR) filter, which may be calibrated during normal operation of station 200 and/or AP 110, if desired. For example, antenna 270 may transmit unacknowledged data message 120 and echo canceller 240 may converge the filter taps of echo canceller 240 according to a power of a received unacknowledged data message and a received noise.

Although the scope of the present invention is not limited in this respect, unacknowledged data message 120 may collide with one or more signals, which may include received signal 130, an echo of unacknowledged data message 120, and a noise. Combiner 250 may combine the power of received signal 120 and canceling signal 245 (e.g. the power of the echo of unacknowledged data message 120) from echo canceller 240, and may provide an interferer signal 255 to detector 260.

According to some embodiments of the invention, decoder 260 may include a threshold. For example, the threshold may be set according to a sum of the separation value (e.g. separation 290), the power of the echo of unacknowledged data message 120, and the received noise, if desired.

Although the scope of the present invention is not limited in this respect, detector 260 may detect a collision of a received signal 130 and a transmission of unacknowledged data message 120 by comparing a value related to the power value of the echo of unacknowledged data message 120, the received signal, and the received noise (e.g. interferer signal 255), to the threshold. Controller 230 may retransmit unacknowledged data message 120 when a collision may detected.

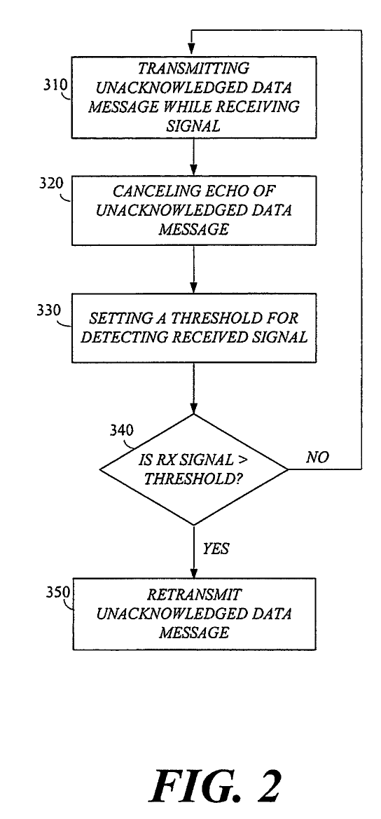

Turning to FIG. 2, a schematic flow chart of a method for detecting collision of a received signal with an unacknowledged data message while transmitting the unacknowledged data message according to exemplary embodiments of the invention is shown. Although the scope of the present invention is not limited in this respect, the method may begin with transmitting unacknowledged data message (e.g. unacknowledged data message) while receiving a received signal (text box 310). According to one exemplary embodiment of the invention, an echo of the unacknowledged data message may be canceled at a receiver (e.g. receiver 210) of a transmitting station or AP (text block 320).

Although the scope of the present invention is not limited in this respect, a threshold for detecting the received signal may be set according to a power of an echo of the unacknowledged data message, a received noise, and a separation between a receiving antenna and a transmitting antenna at the transmitting station and/or AP (text block 330). According to some embodiments of the invention, detecting the collision may include comparing a characteristic value (e.g. a power) of the received signal to a threshold (e.g., the threshold of detector 260). For example, if the characteristic value of the received signal is above the threshold (text box 340), the transmitting station and/or AP may retransmit the unacknowledged data message (text box 350).

According to some embodiments of the invention, the number of retransmissions of the unacknowledged data message may be limited to a predetermined number, for example, ten transmissions, although the scope of the present invention is in no way limited to this example. The method may be repeated for a desired number of transmissions of the unacknowledged data message.

Although the scope of the present invention is not limited in this respect, it should be understood that blocks, units, components, modules and antennas similar to those described with reference to station 200 may be included in other communication devices such as, for example, AP 110, and that the method described with reference to FIG. 2 may be applicable to any suitable communication devices such as, for example, AP 110 and/or station 200. Furthermore, the blocks, units, components, modules and antennas of stations and/or APs, according to embodiments of the invention, may be implemented by hardware or software or by any suitable combination of hardware and/or software.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
during transmission of an unacknowledged data message, detecting a collision between the unacknowledged data message and a received signal; and
retransmitting the unacknowledged data message.

2. The method of claim 1, comprising:
setting a threshold for detecting the received signal; and
detecting the collision by comparing a characteristic value of the received signal to the threshold.

3. The method of claim 2, wherein setting comprises:
canceling from the received signal a power of an echo of the unacknowledged data message; and
setting the threshold to be below the power of the echo of the unacknowledged data message and a received noise.

4. An apparatus comprising:
a transmitter to transmit an unacknowledged data message;
a detector operably coupled to a receiver to detect a collision of a received signal with the unacknowledged data message; and
a controller able to retransmit the unacknowledged data message according to a detection of the collision.

5. The apparatus of claim 4, wherein the detector is able to detect the collision by comparing a power of the received signal to a threshold.

6. The apparatus of claim 4, comprising:
an echo canceller to cancel an echo of the unacknowledged data message from the received signal.

7. The apparatus of claim 6, comprising:
a first antenna to transmit the unacknowledged data message; and
a second antenna to receive the received signal,
wherein a separation between the first antenna to the second antenna is adjusted to a predetermined value.

8. The apparatus of claim 7, wherein the echo canceller is adapted to cancel a signal related to a sum of the separation value, the power of the echo of the unacknowledged data message, and the received noise.

9. A wireless communication system comprising:
a communication device having a transmitter to transmit an unacknowledged data message, a detector operably coupled to a receiver to detect a collision of a received signal with the unacknowledged data message and a controller able to retransmit the unacknowledged data message according to a detection of the collision.

10. The wireless communication system of claim 9, wherein the detector is able to detect the collision by comparing a power of the received signal to a threshold.

11. The wireless communication system of claim 9, wherein the communication device comprises:
an echo canceller to cancel an echo of the unacknowledged data message from the received signal

12. The wireless communication system of claim 11, wherein the communication device comprises:
a first antenna to transmit the unacknowledged data message; and
a second antenna to received the received signal, wherein a separation between the first antenna to the second antenna is adjusted to a predetermined value.

13. The wireless communication system of claim 12, wherein the echo canceller is adapted to cancel a signal related to a sum of the separation value, the power of the echo of the unacknowledged data message and the received noise.

14. A communication device comprising:
a first dipole antenna coupled to a transmitter to transmit an unacknowledged data message;
a second dipole antenna coupled to a receiver to receive a received signal;
a detector operably coupled to the receiver to detect a collision of the received signal with the unacknowledged data message; and
a controller able to retransmit the unacknowledged data message according to a detection of the collision.

15. The communication device of claim 14, wherein the detector is able to detect the collision by comparing a power of the received signal to a threshold.

16. The communication device of claim 14, comprising:
an echo canceller to cancel an echo of the unacknowledged data message from the received signal.

17. The communication device of claim 16, wherein a separation between the first dipole antenna to the second dipole antenna is adjusted to a predetermined value.

18. The communication device of claim 17, wherein the echo canceller is adapted to cancel a signal related to a sum of the separation value, the power of the echo of the unacknowledged data message and the received noise.

19. An article comprising: a storage medium, having stored thereon instructions, that when executed, result in:
during transmission of an unacknowledged data message, detecting a collision between the unacknowledged data message and a received signal; and
retransmitting the unacknowledged data message.

20. The article of claim 19, wherein the instructions when executed result in:
setting a threshold for detecting the received signal; and
detecting the collision by comparing a characteristic value of the received signal to the threshold.

21. The article of claim 20, wherein the instructions when executed result in:
canceling from the received signal a power of an echo of the unacknowledged data message; and
setting the threshold to be below the power of the echo of the unacknowledged data message and a received noise.
